(19) United States
(12) Patent Application Publication
(10) Pub. No.: US 2006/0098816 A1
(43) Pub. Date: May 11, 2006

(54) Process of and apparatus for encoding a signal

(76) Inventor: Sean O'Neil, Fortitude Valley (AU)

Correspondence Address: HOFFMAN, WASSON & GITLER, P.C.;SUITE 522, 2461 SOUTH CLARK STREET, CRYSTAL CENTER 2, ARLINGTON, VA, 22202, US

(21) Appl. No.: 11/267,188

(22) Filed: Nov. 7, 2005

(30) Foreign Application Priority Data
Nov. 5, 2004 (AU) 2004906364
Jan. 10, 2005 (AU) 2005900087
May 10, 2005 (WO) PCT/IB05/01487

(51) Int. Cl. H04L 9/30

(52) U.S. Cl. 380/30

(57) ABSTRACT

A cryptographic process includes an initialization process, invokes at least one round function (171, 172, 281, 282) and has an output function. The initialization process initializes intermediate text (150, 250) which has more than 58 octets. Each round function (171, 172, 281, 282) updates the intermediate text. Each round function (171, 172, 281, 282) has one input selected from the intermediate text (150, 250), at least two inputs selected from the intermediate text (150, 250), so that each pair of the at least two inputs selected from the intermediate text (150, 250) is separated by at least one bit of intermediate text (150, 250). Each of the inputs is at least two bits in length. The sum of the length of the inputs received by the round function (171, 172, 281, 282) from the intermediate text (150, 250) is less than the length of the intermediate text (150, 250) in bits minus six times the length of the sum of the output bits of the round function (171, 172, 281, 282). The output function releases a set of bits from the intermediate text (150, 250).

The present application claims priority from the following applications:

Australian provisional application 2004906364 filed on 5 Nov. 2004;

Australian provisional application 2005900087 filed on 10 Jan. 2005; and

International Patent Application PCT/IB2005/001487 filed on 10 May 2005, the contents of each of which is incorporated herein by reference.

The present application is also related to our copending International Patent Applications:

PCT/IB2005/001475 filed on 10 May 2005; and

PCT/IB2005/001499 filed on 10 May 2005, the contents of each of which is incorporated herein by reference.

### FIELD OF THE INVENTION

The present invention relates to cryptographic functions.

### BACKGROUND OF THE INVENTION

Throughout this specification, including the claims:
use the term ‘secret key material’ refers to material that consists of at least one secret key or material derived from that at least one secret key. We use the term ‘key material’ synonymously with the term ‘secret key material’;
when we refer to blocks of data, key or hash bits, it is to be understood that they are of arbitrary size, not necessarily identical in size, and depend on the function receiving input or generating output;
we use the term ‘secret key material’ to refer to material that consists of at least one secret key or material directly derived from that at least one secret key; and
we use the term ‘key material’ synonymously with the term ‘secret key material; and
we use the term ‘balanced constant’ to refer to constants chosen as balanced log(N)-bit Boolean functions (consisting of 50% binary zero digits) with high non-linearity and which satisfy other cryptographic properties including but not limited to those as described in the masters thesis ‘On the Design of S-Boxes’ by A. F. Webster and S. E. Tavares, Department of Electrical Engineering, Queen's University, Kingston, Ont. Canada, published in LNCS no. 218, pp. 523-534 (1986).

In the art, a linear cryptographic function is understood to be a function of any given number of inputs and any given number of outputs such that the relationship between every bit of output and every bit of input is a polynomial of a degree not higher than one.

A typical linear cryptographic function is a set of bits each of which is an XOR of a number of input bits. All linear cryptographic functions are reversible. There are no irreversible linear cryptographic functions. (An illustration of the sense that the term ‘polynomial’ has in the present art is in the analysis of linear feedback shift registers which is set out at pages 372 to 379 of the book Applied Cryptography: Protocols, Algorithms, and Source Code in C by Bruce Schneier, second edition, 1996.)

A cryptographic function is called reversible regarding a given input if the computational cost of finding the value of that input knowing the output and all other inputs is comparable with the computational cost of calculation of the cryptographic function itself. Addition modulo 2ⁿ, multiplication modulo 2ⁿ and multiplicative inverse modulo 2ⁿ are typical reversible nonlinear cryptographic functions.

A cryptographic function is called irreversible regarding a given input if the computational cost of finding the value of that input knowing the output and all other inputs is either computationally infeasible or extremely high comparing with the computational cost of calculation of the cryptographic function itself. y=x<<<x (x rotated left by x bit) is a typical example of an irreversible nonlinear cryptographic function.

The reversibility of a nonlinear cryptographic function regarding any of its inputs is determined individually for each input. Any given nonlinear cryptographic function may be reversible regarding one input and irreversible regarding another or it can be either reversible or irreversible regarding all its inputs.

For example, a block cipher is a reversible nonlinear cryptographic function regarding its plaintext input, but it is irreversible regarding its key, and a keyed cryptographic hash is irreversible regarding its inputs, data and key.

A linear combination of nonlinear cryptographic functions is also a nonlinear cryptographic function. A nonlinear cryptographic function of a linear combination of its inputs is also a nonlinear cryptographic function. Both these cases are referred to as ‘a nonlinear cryptographic function’ in this specification and are marked according to their reversibility regarding the current block as one of the inputs.

If a nonlinear cryptographic function is reversible regarding one of its inputs x, then a reversible linear or nonlinear combination of that input x or that function's output with any other input is also a nonlinear cryptographic function reversible regarding that input x.

If a nonlinear cryptographic function is irreversible regarding one of its inputs x, then a combination of one or more of its inputs and/or its output with any other cryptographic function, linear or nonlinear, reversible or irreversible is also irreversible regarding that input x.

Cryptographic encryption operations, in general, receive plaintext and generate intermediate text. That intermediate text is received by further cryptographic encryption operations which update a portion of the intermediate text in a nonlinear fashion. After yet further encryption operations are completed, the final intermediate text is released as ciphertext.

A cryptographic encryption operation that generates intermediate text, in general, is referred to as a round function. Round functions may in turn invoke sub-round functions.

The same terminology of intermediate text and round function is also used where the overall cryptographic operation is a decryption process.

Counters are used in cryptographic applications to ensure guaranteed minimum period loops. The simplest such example is achieved by incrementing an n-bit counter modulo n. Counters may be linear or nonlinear.

A broad range of encryption techniques have been used in stream cipher constructions. A brief survey of different types of stream ciphers includes:
linear feed back shift register, stop-go, etc.
   U.S. Pat. No. 3,522,374 (Abrahamsen) published Jul. 28, 1970
   U.S. Pat. No. 3,700,806 (Vasseur) published Oct. 24, 1972
linear parallel feed back shift register
   M. Y. Hsiao, ‘Generating PN Sequences in Parallel’, 3^{rd} Annual Princeton Conference on Information Sciences and Systems, March, pp. 397-401 1969.
   U.S. Pat. No. 3,920,894 (Shirley) published in Nov. 18, 1975
   C. Gunther, ‘Parallel generation of recurring sequences’, Eurocrypt 1989, p. 504-522
   U.S. Pat. No. 4,965,881 (Dilley) published Oct. 23, 1990.
linear parallel feed forward shift register
   U.S. Pat. No. 4,755,987 (Lee) published in Jul. 5, 1988
linear windmill constructions
   B. Smeets, ‘Some Properties of Sequences Generated by a Windmill Machine’, Eurocrypt 20-22 May 1986, Linkoping, Sweden.
   U.S. Pat. No. 3,784,743 (Schroeder) published Jan. 8, 1974
linear windmill constructions implemented in word based architectures
   U.S. Pat. No. 5,745,522 (Heegard) published Apr. 28, 1998
   U.S. Pat. No. 6,339,645 B2 (Smeets) published Jan. 2, 2002
hybrid nonlinear feedback shift register constructions
   U.S. Pat. No. 3,925,611 (Dennis) published Dec. 9, 1975
   U.S. Pat. No. 4,004,809 (Richard) published Jan. 18, 1977
counter mode of operation for block ciphers
linear feedback shift register with nonlinear filter function
   U.S. Pat. No. 3,250,855 (Vasseur) published in May 10, 1966
word based non linear feedback shift register
   U.S. Pat. No. 4,107,458 (Constant) published in Aug. 15, 1978
   U.S. Pat. No. 4,776,011 (Buby) published in Oct. 4, 1988
output feedback mode of operation for block ciphers
   U.S. Pat. No. 4,160,120 (Barnes) published Jul. 3, 1979
   U.S. Pat. No. 4,503,287 (Morris) published Mar. 5, 1985
   U.S. Pat. No. 4,731,843 (Holmsquit) published Mar. 15, 1988
   U.S. Pat. No. 4,802,217 (Michener) published in Jan. 31, 1989
word based linear feedback shift register with nonlinear feedback shift register
   The ‘MUGI’ cipher by the Hitachi Ltd, ‘MUGI—Pseudorandom Number Generator—Specification Ver 1.2’, Dec. 18, 2001.
word based nonlinear feedback shift register, using a linear combiner selecting multiple blocks into a block cipher, updating one block
   The Seal cipher by Philip Rogaway and Don Coppersmith, ‘A Software-Optimized Encryption Algorithm’ published in Fast Software Encryption, Cambridge Security Workship Proceedings, Springer-Verla, 1994, pp 56-63
   The Scream cipher by Shai Halevi, Don Coppersmith, Charanjit Jutla, ‘Scream: a software-efficient stream cipher’, Fast Software Encryption, preproceedings of FSE 2002, pp 190-204, 2002.
   Related Pat. Nos. include the U.S. Pat. No. 5,454,039 (Coppersmith) published and U.S. Pat. No. 5,675,52 (Coppersmith) published.
word based linear feedback shift register updating entire intermediate text in parallel
   U.S. Pat. No. 4,897,876 (Davies) published Jan. 30, 1990
   Sarkar, P.: Hiji-bij-bij: A New Stream Cipher with a Self-synchronizing Mode of Operation, in Proc. Of Progress in Cryptology—INDOCRYPT 2003, 4th International Conference on Cryptology in India, New Delphi, India, December 2003, Springer-Verlag, Lecture Notes in Computer Science, Vol. 2904, pp. 36-51, 2003
   International Pat. No. application WO 2003/104,969 A2 (Cryptico A/S) published 18 Dec. 2003.
transposition of user-data cipher
   U.S. Pat. No. 4,087,626 (Brader) published May. 2, 1978
   U.S. Pat. No. 4,316,055 (Feistel) published Feb. 16, 1982
transposition of intermediate text of cipher
   The Arcfour cipher published under the title ‘A Stream Cipher Encryption Algorithm Arcfour’, as an INTERNET-DRAFT of the IETF dated 14 Jul. 1999 by K. Kaukonen and R.Thayer.
   The Sapphire and Sapphire-II stream ciphers by Michael Paul Johnson that do not appear to have formally published printed specifications.
   The VMPC Stream Cipher by Bartosz Zoltak, ‘VMPC One-Way Function and Stream Cipher’ published in Fast Software Encryption international conference, 5-7 Feb. 2004.

The steps employed to implement a stream cipher process share significant similarities with the steps employed to implement a block cipher. There is a general class of cryptographic word based stream ciphers, as disclosed above, where in general they receive a secret key that is used to initialize an intermediate text. The intermediate text is received by non linear round functions that update the intermediate text. A portion of intermediate text less than or equal to half the length of the intermediate text is released as keystream output of the stream cipher. The process of updating the intermediate text with cryptographic operations and releasing a portion of intermediate text continues as required by the user of the stream cipher. This process results in an expansion of the original secret key material supplied to the intermediate text. Expansion functions are generally understood to release significantly larger amount of intermediate text in comparison to the material received as secret input external to the module.

A more detailed review of the most relevant stream ciphers with intermediate text updated with a non linear round function follows.

The first example of a non linear feedback shift register updating a small portion of a large intermediate text is disclosed in the above-mentioned U.S. Pat. No. 4,107,458 (Constant) (1978). The stream cipher is described as having been derived from delay time compressor techniques (DELTIC). A single round of a DES module is used to update the intermediate text. A careful analysis of FIG. 5 reveals that the individual blocks of the intermediate text 4 do not become interrelated over time.

The above-mentioned U.S. Pat. No. 4,160,120 (Barnes) (1979) discloses a non linear feedback shift register with two intermediate text buffers. FIG. 7 illustrates one variation of the invention with two intermediate text buffers 7-2 and 7-30. The 56 bytes out of 64 bytes of intermediate text 7-30 are fed back for every bit of output generated. In addition the single bit of output is stored in intermediate text 7-2, storing the output of 64 discrete ciphertext outputs. After 64 iterations, such that the single bit output 7-32 has been loaded into 7-2, each additional bit loaded into 7-2 is assured to have a dependency on every other bit in 7-2. The invention has very carefully selected buffers that cannot be arbitrarily adjusted for the DES module 7-6.

The above-mentioned U.S. Pat. No. 4,503,287 (Morris) (1985) illustrates the classic cipher feedback (CFB) mode of operation. The intermediate text 50 is a sixty-four bit shift register rotated 8 bits every complete DES invocation. Every bit of the intermediate text 50 is involved in the generation of the output that is fed back into the intermediate text. It is clear that significant portions of the DES circuitry may be optimized away as they do not influence the feedback.

The above-mentioned U.S. Pat. No. 4,731,843 (Holmquist) (1988) illustrates a parallelized version of the (CFB) mode of operation. The intermediate text 70 is 63-bits+k-bits where k is the number of DES engines releasing a single bit of output. Every bit of the intermediate text 70 is involved in the generation of the output that is fed back into the intermediate text. It is also clear that significant portions of the DES circuitry may be optimized away as they do not influence the feedback.

The above-mentioned U.S. Pat. No. 4,802,217 (Michener) (1989) illustrates the use of DES as a nonlinear round function to update the intermediate text. FIG. 7 illustrates five sixty-four bit blocks of intermediate state updated sixty-four bits at a time. The first block of the intermediate text by the DES module is fed back into the DES module only after three additional rounds. The output of the DES module is supplied as key input into a second DES module performing a nonlinear filter of the plaintext message generating a ciphertext.

FIGS. 8a and 8b (of Michener) illustrate a variation of the above invention such that one block of reversible input supplied as plaintext input into the DES engine and the same block of intermediate text being updated by the output, with the irreversible key input including material to be supplied as reversible input in the next round.

The intermediate text updated by the first DES module in encryption mode can be reversed, by running the DES module in decryption mode and decoding blocks in the inverse order they were encrypted.

### SUMMARY OF THE INVENTION

The invention provides a process comprising an initialization process comprising the initialization of intermediate text, where the intermediate text is larger than 58 octets. Also, an updating process comprises the invocation of at least one round function, each round function receives inputs comprising one input selected from the intermediate text; at least two inputs selected from the intermediate text, so that each pair of the at least two inputs selected from the intermediate text is separated by at least one bit of intermediate text. Each of the inputs is at least two bits in length generating at least one output that updates the intermediate text where at least two bits of the intermediate text is updated.

The sum of the length of the inputs received by the round function from the intermediate text is less than the length of the intermediate text in bits minus six times the length of the sum of the output bits of the round function. An output function releases a set of bits from the intermediate text.

### BRIEF DESCRIPTION OF THE DRAWINGS

FIG. 1 illustrates a first step in the process;

FIG. 2 illustrates a second step in the process; and

FIG. 3 illustrates a process according to another preferred embodiment of the present invention.

### DESCRIPTION OF PREFERRED EMBODIMENTS OF THE INVENTION

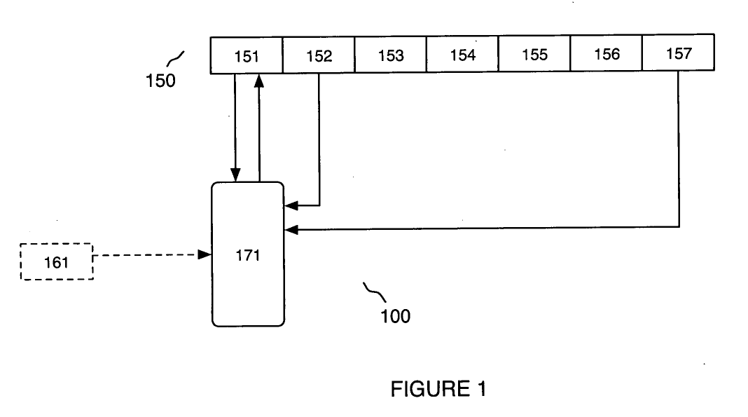

In FIG. 1, reference number 150 indicates seven blocks 151 to 157 of intermediate text. The intermediate text 150 is of variable length and is illustrated as seven blocks in length. The intermediate text 150 is taken as a contiguous sequence of blocks during coding operations. Block 161 is zero or more blocks of irreversible input. Round function invocation 171 receives three consecutive blocks 157, 151 and 152 of inputs from the intermediate text 150. Round function invocation 171 releases as output material updating block 151.

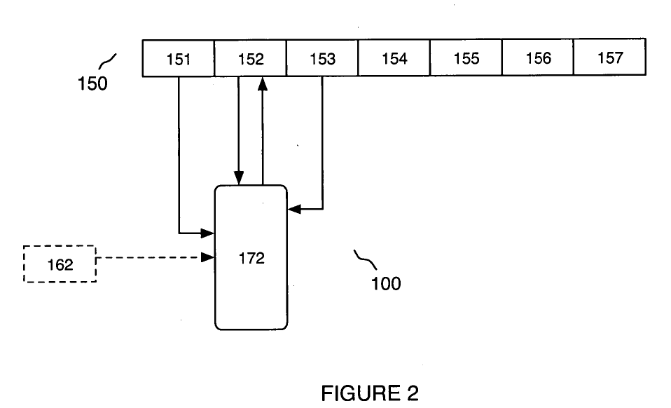

FIG. 2 illustrates the second step of the process of FIG. 1.

Round function invocation 172 receives three consecutive blocks 151, 152 and 153 of input from the intermediate text 150. Block 162 is zero or more blocks of irreversible input. Round function invocation 172 releases as output material updating block 152. It is preferred that the round function of invocation 172 is the same as the round function of invocation 171 but in FIG. 2 it is given the reference number 172 for ease of discussion.

The round function invocation 172 takes as input the output of the previous round function invocation 171, one of the unmodified inputs 152 of the previous round function invocation, and one block of input 153 not received as input to the previous round function invocation 171. The output of round function invocation 172 updates the block 152 of input of the previous round function invocation 171.

The hashing of the intermediate text continues as illustrated by the transition from FIG. 1 to FIG. 2.

It is to be appreciated that for each round function invocation, after the first round function invocation, the current round function invocation takes as input the output of the immediately previous round function invocation, ensuring the most rapid avalanche and replaces one of the unmodified inputs of the immediately previous round function invocation, ensuring part of the information used to calculate the previous output is modified. This modification of the irreversible input to the previous round creates a strict chronological dependency in the forwards and backwards direction that improves the security of the construction.

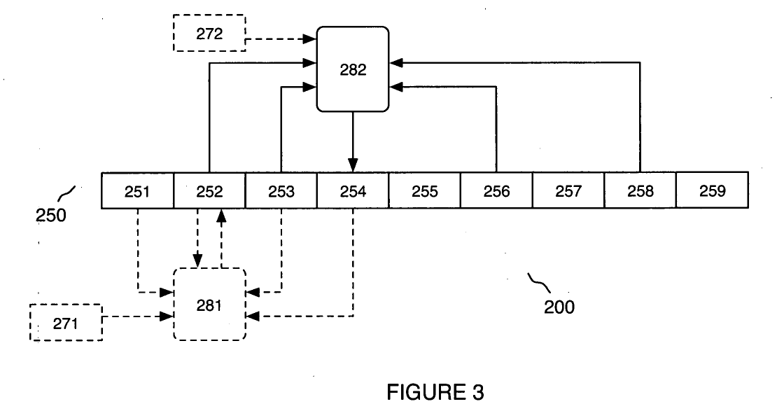

FIG. 3 illustrates another preferred embodiment of the present invention.

Reference number 250 indicates nine blocks 251 to 259 of intermediate text. The intermediate text 250 is of variable length and is illustrated as nine blocks in length. The intermediate text 250 is taken as a contiguous sequence of blocks during coding operations. Block 271 is zero or more blocks of irreversible input. Block 272 is zero or more blocks of irreversible input.

The previous round function invocation 281 takes as 4 blocks of input 251, 252, 253 and 254. The round function invocation 281 releases as output 252.

The round function invocation 282 takes as input the output of the previous round function invocation 281, one of the unmodified inputs 253 of the previous round function invocation 281, and two blocks of input 256 and 258 not received as input to the previous round function invocation 281. The output of round function invocation 282 updates a block 254 of input of the previous round function invocation 281. It is preferred that round function of invocation 281 is the same as the round function of invocation 282 for ease of discussion.

The process of operation of the stream cipher involves the initialization of the intermediate text followed by a process of updating the intermediate text that comprises a round function updating the intermediate text and an output function that generates output derived from the intermediate text. The updating process is invoked as many times as required by the user. The intermediate text is normally reinitialized when the larger cipher it comprises a part of is also reinitialized.

In a preferred variation of the present invention the intermediate text is initialized with a secret key.

In a preferred variation of the present invention the intermediate text is initialized with a constant key and the secret key is supplied as input to at least one round function.

In a preferred variation of the current invention the round function is supplied with counter material for the purpose of ensuring minimum guaranteed period lengths.

In a preferred variation of the current invention the output of the round function invocation updating the intermediate text is supplied as input to a nonlinear and filter function and the generated output is released to another process. In a preferred variation of the current invention the set of inputs supplied to the round function invocation updating the intermediate text is also supplied as input to a filter function and the generated output is released to another process. In a preferred variations the filter function is a nonlinear filter function. In a preferred variation the filter function is a keyed nonliner filter function. In a preferred variation the filter function is a block cipher comprising a process with multiple rounds.

In a preferred variation of the current invention a unique selection of inputs is supplied as input to a filter function and the generated output is released to another process, such that the intermediate text supplied to the filter function is different to the intermediate text supplied to the round function invocation updating the intermediate text.

In a preferred variation of the current invention the filter function receives both the output of the round function invocation and material selected from the intermediate text not supplied as input.

In a preferred variation of the current invention more than one block of intermediate text is updated before any material is released as output.

In a preferred variation of the current invention the round function invocation is supplied with the output of the stream cipher resulting in output feedback mode of operation.

In a preferred variation there are two unique round functions updating the intermediate text, the first used during the initialization process and the other round function used during the updating process.

In a preferred variation of the current invention the round function is a block cipher. In a preferred variation of the current described embodiment the block cipher has irreversible inputs that are at least twice the length of the reversible input, such as a 128-bit block cipher that employs a 256-bit key. In a preferred variation of the currently described embodiment, the block cipher has fewer rounds than is required for the output of the block cipher invocation to be a cryptographically secure on its own right.

In a preferred variation of the currently describe embodiment the block cipher is a tweakable block cipher such that the secret key and ‘tweakable’ input is adapted to receive intermediate text.

In a preferred embodiment the blocks are thirty-two bits in length executing on a 32-bit processor with thirty-two bit wide operations efficient on the thirty-two bit processor. In a preferred embodiment the blocks are sixty-four bits in length executing on a 64-bit processor with 64-bit wide operations efficient on the 64-bit processor.

It is to be appreciated that a stream cipher is a class of pseudorandom number generator, and that pseudorandom number generators have broad application outside of cryptographic applications.

It is readily appreciated that several optimizations are possible when implementing dedicated round functions and filter functions. For instance the round function updating the intermediate text and nonlinear filter may be optimized to share common logic.

Although we have described detailed embodiments of the invention, with a number of variations, which incorporate the teachings of the present invention, the skilled reader of this specification can readily devise other embodiments and applications of the present invention that utilize these teachings.

1. A process comprising:
an initialization process comprising the initialization of intermediate text,
where the intermediate text is larger than 58 octets;
an updating process comprising:
the invocation of at least one round function, each round function:
receiving inputs comprising:
one input selected from the intermediate text;
at least two inputs selected from the intermediate text, so that each pair of the at least two inputs selected from the intermediate text is separated by at least one bit of intermediate text; and
each of the inputs is at least two bits in length
generating at least one output that updates the intermediate text;
where at least two bits of the intermediate text is updated;
and in which:
the sum of the length of the inputs received by the round function from the intermediate text is less than the length of the intermediate text in bits minus six times the length of the sum of the output bits of the round function; and
an output function which releases a set of bits from the intermediate text.

2. A process as claimed in claim 1, in which at least a portion of at least one of the inputs to at least one round function invocation is selected as the output of the selected round function's immediately preceding round function invocation.

3. A process as claimed in claim 1, in which at least a portion of at-least one of-the inputs to a round function invocation is selected as one of the inputs to the previous round function invocation that was not updated by the output of the previous round function.

4. A process as claimed in claim 1, in which at least a portion of at least one of the inputs to the an invocation of at least one round function is selected from a region of intermediate text which:
was not selected as input to the selected round function's immediately preceding round function invocation; and
is not material which was updated by the output of the selected round function invocation's immediately preceding round function invocation.

5. A process as claimed in claim 1, in which at least a portion of a region of intermediate text which was supplied as input to an invocation of a round function is updated by the output of that invocation of the round function.

6. A process as claimed in claim 1, in which the at least a portion of a region of intermediate text that is supplied to an invocation of a round function is supplied as irreversible input and the output of that invocation of the round function updates a portion of a region of intermediate text that was input as reversible input to the immediately previous round function invocation of the selected round.

7. A process as claimed in claim 1, in which each time the intermediate text is updated, the length of the output released by the output function is less than the length of the intermediate text updated.

8. Apparatus comprising:
an initialization module which is adapted to initialize intermediate text, the intermediate text being larger than 58 octets;
an updating module comprising:
a round function module which implements the invocation of at least one round function, each- round function:
receiving inputs comprising:
one input selected from the intermediate text;
at least two inputs selected from the intermediate text, so that each pair of the at least two inputs selected from the intermediate text is separated by at least one bit of intermediate text; and
each of the inputs is at least two bits in length
generating at least one output that updates the intermediate text;
where at least two bits of the intermediate text is updated;
and in which:
the sum of the length of the inputs received by the round function from the intermediate text is less than the length of the intermediate text in bits minus six times the length of the sum of the output bits of the round function; and
a module which releases a set of bits from the intermediate text.

9. Apparatus as claimed in claim 8, in which at least a portion of at least one of the inputs to at least one round function invocation is selected as the output of the selected round function's immediately preceding round function invocation.

10. Apparatus as claimed in claim 8, in which at least a portion of at least one of the inputs to a round function invocation is selected as one of the inputs to the previous round function invocation that was not updated by the output of the previous round function.

11. Apparatus as claimed in claim 8, in which at least a portion of at least one of the inputs to the an invocation of at least one round function is selected from a region of intermediate text which:
was not selected as input to the selected round function's immediately preceding round function invocation; and
is not material which was updated by the output of the selected round function invocation's immediately preceding round function invocation.

12. Apparatus as claimed in claim 8, in which at least a portion of a region of intermediate text was supplied as input to an invocation of a round function is updated by the output of that invocation of the round function.

13. Apparatus as claimed in claim 8, in which the at least a portion of a region of intermediate text that is supplied to an invocation of a round function is supplied as irreversible input and the output of that invocation of the round function updates a portion of a region of intermediate text that was input as reversible input to the immediately previous round function invocation of the selected round function invocation.

14. Apparatus as claimed in claim 8, in which each time the intermediate text is updated, the length of the output released by the output function is less than the length of the intermediate text updated.
